(19) United States
(12) Patent Application Publication
(10) Pub. No.: US 2006/0250761 A1
(43) Pub. Date: Nov. 9, 2006

(54) Electronic device

(75) Inventors: Chu Chia Tsai, Taipei (TW); Hsiu Wei Yeh, Taipei (TW)

Correspondence Address: QUINTERO LAW OFFICE, 1617 BROADWAY, 3RD FLOOR, SANTA MONICA, CA, 90404, US

(73) Assignee: WISTRON CORP., TAIPEI HSIEN (TW)

(21) Appl. No.: 11/192,799

(22) Filed: Jul. 29, 2005

(30) Foreign Application Priority Data
May 4, 2005 (TW) TW94207117

(51) Int. Cl. G06F 1/16

(52) U.S. Cl. 361/681

(57) ABSTRACT

An electronic device. A fixed base is fixed to a host. A first rotating base is rotatably disposed on the fixed base and rotates in a first direction with respect to the fixed base. A second rotating base is rotatably disposed on the first rotating base and rotates in a second direction with respect to the first rotating base. The central rotating axis of the second direction is perpendicular to that of the first direction. A supporting frame is rotatably connected to the second rotating base and rotates in a third direction with respect to the second rotating base. The central rotating axis of the third direction is perpendicular to that of the second direction. A monitor is connected to the supporting frame and rotates in the first, second, and third directions with respect to the host by the first rotating base, second rotating base, and supporting frame, respectively.

### BACKGROUND

The invention relates to an electronic device, and in particular to a notebook computer with an LCD monitor capable of rotation in three directions with respect to a host.

Notebook computers often have reduced size due to considerations of portability. The size of an LCD monitor is reduced corresponding to the reduced size of the notebook computer. An additional and relatively large monitor can often be connected to the notebook computer in residence or offices, serving as an operation interface. Accordingly, the LCD monitor of the notebook computer is often unused in residence or offices.

Moreover, enhanced windows-based operating systems often provide function for multiple monitors. Thus, connecting other monitors to a notebook computer with an LCD monitor in a more convenient manner is increasingly critical.

Hence, there is a need for an improved notebook computer in which an LCD monitor is capable of rotation in three directions with respect to a host. When additional monitors are connected to the host or multiple monitors are used, the LCD monitor can rotate to one side of the host, facilitating operation thereof.

### SUMMARY

Accordingly, an exemplary embodiment of the invention provides an electronic device comprising a host, a fixed base, a first rotating base, a second rotating base, a supporting frame, and a monitor. The fixed base is fixed to the host. The first rotating base is rotatably disposed on the fixed base and rotates in a first direction with respect to the fixed base. The second rotating base is rotatably disposed on the first rotating base and rotates in a second direction with respect to the first rotating base. The central rotating axis of the second direction is perpendicular to that of the first direction. The supporting frame is rotatably connected to the second rotating base and rotates in a third direction with respect to the second rotating base. The central rotating axis of the third direction is perpendicular to that of the second direction. The monitor is connected to the supporting frame and rotates in the first, second, and third directions with respect to the host by way of the first rotating base, second rotating base, and supporting frame, respectively.

The electronic device further comprises a first pivot disposed in the fixed base and first rotating base. The first rotating base rotates in the first direction with respect to the fixed base by the first pivot.

The electronic device further comprises a second pivot disposed in the first and second rotating bases. The second rotating base rotates in the second direction with respect to the first rotating base by the second pivot.

The electronic device further comprises a third pivot disposed in the supporting frame and second rotating base. The supporting frame rotates in the third direction with respect to the second rotating base by the third pivot.

The second rotating base further comprises a through hole, through which a signal cable is passed, by means of which the monitor is electrically connected to the host.

The second rotating base further comprises an engaging hook, and the host further comprises an engaging hole to which the engaging hook is selectively engaged.

The fixed base is fixed-to one corner of the host.

The fixed base further comprises a base plate and two first pivoting portions. The first pivoting portions protrude from the base plate. The first rotating base is disposed between the first pivoting portions and separated from the base plate. Each first pivoting portion comprises a first pivot hole. The first rotating base comprises a second pivot hole. The first pivot is disposed in the first and second pivot holes.

The first rotating base further comprises two second pivoting portions, each second pivoting portion comprising a third pivot hole. The second rotating base is disposed between the second pivoting portions and comprises a fourth pivot hole. The second pivot is disposed in the third and fourth pivot holes.

The monitor comprises an LCD monitor, and the electronic device comprises a notebook computer.

### DESCRIPTION OF THE DRAWINGS

The invention can be more fully understood by reading the subsequent detailed description and examples with references made to the accompanying drawings, wherein:

FIG. 1 is a schematic perspective view of the notebook computer (electronic device) of the invention;

FIG. 2 is a schematic perspective view of the multi-directional rotating mechanism of FIG. 1;

FIG. 3 is an exploded perspective view of FIG. 2;

FIG. 4 is a schematic perspective view showing operation of the notebook computer (electronic device) of the invention;

FIG. 5 is another schematic perspective view showing operation of the notebook computer (electronic device) of the invention; and

FIG. 6 is a schematic plan view of the multi-directional rotating mechanism of FIG. 5.

### DETAILED DESCRIPTION

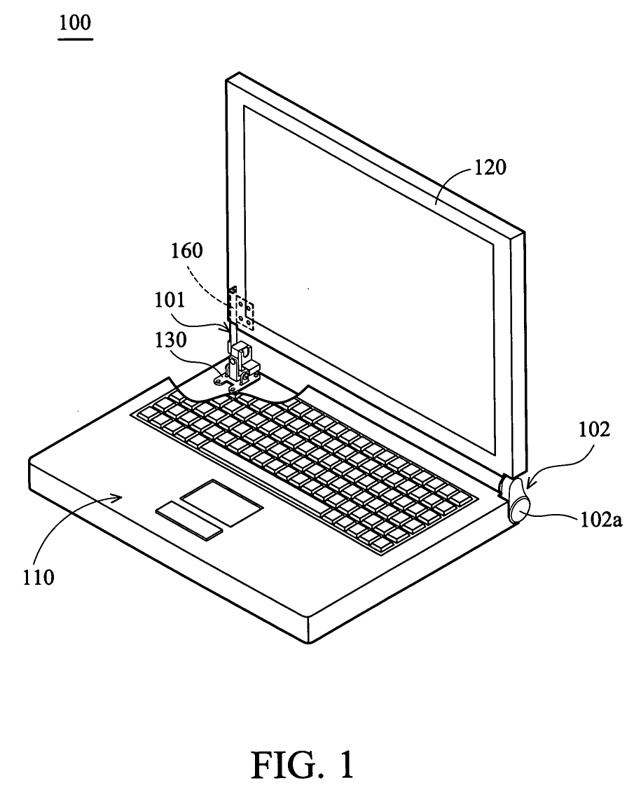

Referring to FIG. 1, the notebook computer (electronic device) 100 comprises a host 110 and an LCD monitor 120. The LCD monitor 120 is connected to the host 110 by means of a multi-directional rotating mechanism 101 and a release/lock hinge 102, rotating with respect to the host 110. The release/lock hinge 102 may be a conventional structure. The LCD monitor 120 can rotatably open from and close onto the host 110 by way of the release/lock hinge 102. Moreover, when a button 102a of the release/lock hinge 102 is pressed, one end of the LCD monitor 120 can be separated from the release/lock hinge 102 (or host 110).

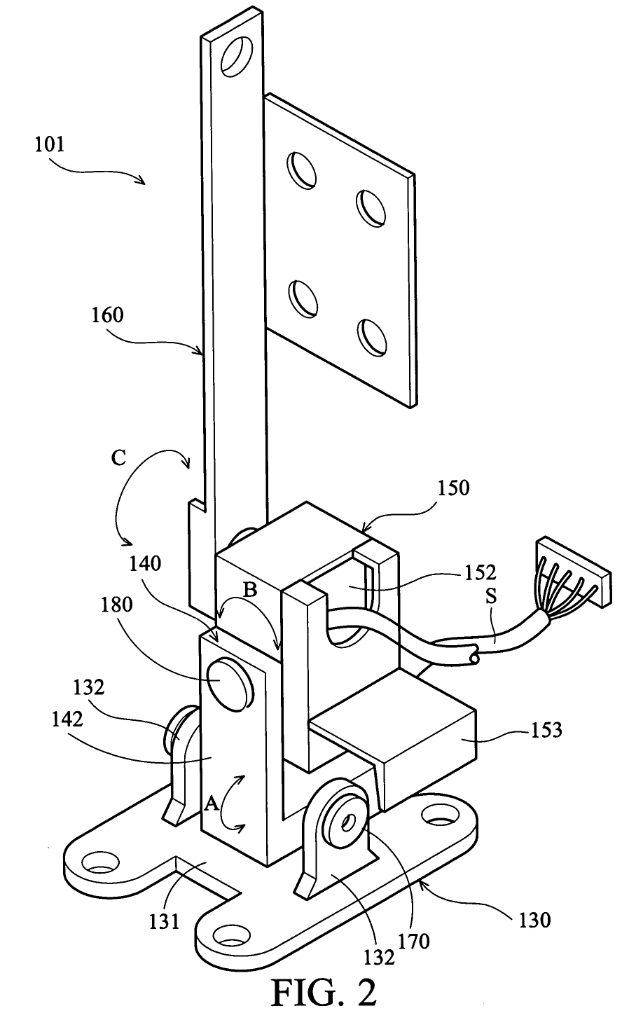

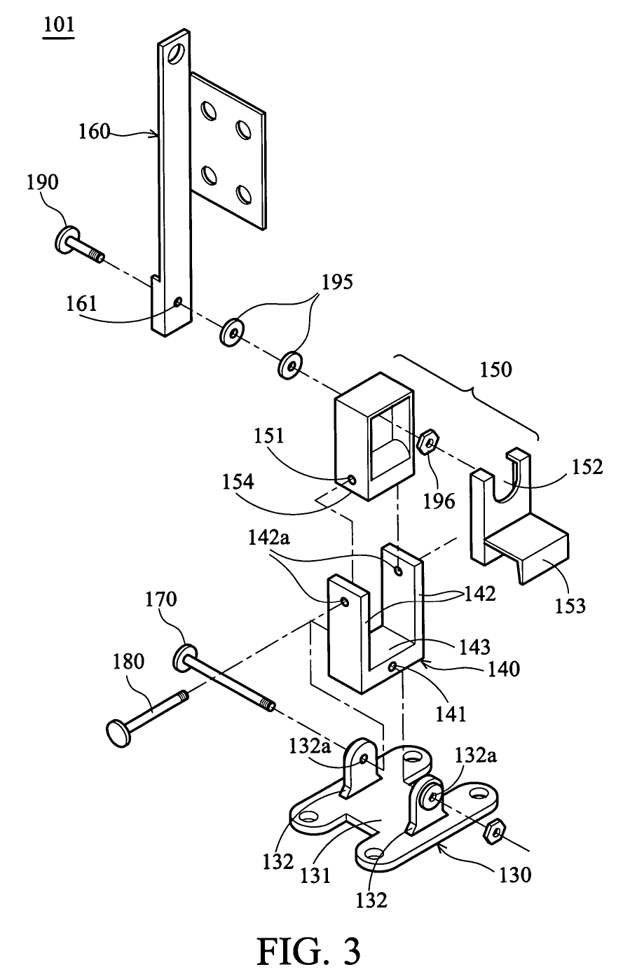

Referring to FIG. 2 and FIG. 3, the multi-directional rotating mechanism 101 comprises a fixed base 130, a first rotating base 140, a second rotating base 150, a supporting frame 160, a first pivot 170, a second pivot 180, and a third pivot 190.

The fixed base 130 is fixed to the host 110. Specifically, as shown in FIG. 1, the fixed base 130 is fixed to one corner of the host 110. Additionally, the fixed base 130 comprises a base plate 131 and two first pivoting portions 132 protruding from the base plate 131. Each first pivoting portion 132 further comprises a first pivot hole 132a.

The first rotating base 140 is rotatably disposed on the fixed base 130. Specifically, the first rotating base 140 comprises a second pivot hole 141 and two second pivoting portions 142. Each second pivoting portion 142 further comprises a third pivot hole 142a. The first rotating base 140 is disposed between the first pivoting portions 132 of the fixed base 130 and is separated from the base plate 131 thereof. The first pivot 170 is disposed in the first pivot holes 132a of the first pivoting portions 132 and the second pivot hole 141 of the first rotating base 140. Accordingly, the first rotating base 140 can rotate in a first direction A with respect to the fixed base 130 by way of the first pivot 170.

The second rotating base 150 is rotatably disposed on the first rotating base 140. Specifically, the second rotating base 150 comprises a fourth pivot hole 151, a through hole 152, and an engaging hook 153 and is disposed between the second pivoting portions 142 of the first rotating base 140. A bottom surface 154 of the second rotating base 150 is separated from a top surface 143 of the first rotating base 140. The second pivot 180 is disposed in the third pivot holes 142a of the second pivoting portions 142 and the fourth pivot hole 151 of the second rotating base 150. Accordingly, the second rotating base 150 can rotate in a second direction B with respect to the first rotating base 140 by way of the second pivot 180. Specifically, the central rotating axis of the second direction B is perpendicular to that of the first direction A.

The supporting frame 160 is rotatably connected to the second rotating base 150. Specifically, the third pivot 190 is sequentially disposed in a fifth pivot hole 161 of the supporting frame 160, two washers 195, and the second rotating base 150. Additionally, the second rotating base 150 comprises a hole (not shown) near the washers 195, and a nut 196 is disposed in the second rotating base 150. The third pivot 190 is sequentially disposed in the fifth pivot hole 161 of the supporting frame 160, washers 195, hole of the second rotating base 150, and nut 196, and the third pivot 190 and nut 196 are fastened together. Accordingly, the third pivot 190 is not separated from the second rotating base 150. Thus, the supporting frame 160 can rotate in a third direction C with respect to the second rotating base 150 by way of the third pivot 190. Specifically, the central rotating axis of the third direction C is perpendicular to that of the second direction B.

The LCD monitor 120 is connected to the supporting frame 160 or, in other words, the supporting frame 160 is disposed in the LCD monitor 120. Accordingly, the LCD monitor 120 can rotate in the first direction A, second direction B, and third direction C with respect to the host 110 by way of the first rotating base 140, second rotating base 150, and supporting frame 160, respectively. Additionally, the LCD monitor 120 is electrically connected to the host 110 by a signal cable S. Specifically, the signal cable S connects the LCD monitor 120 to the host 110 via the through hole 152 of the second rotating base 150, as shown in FIG. 2.

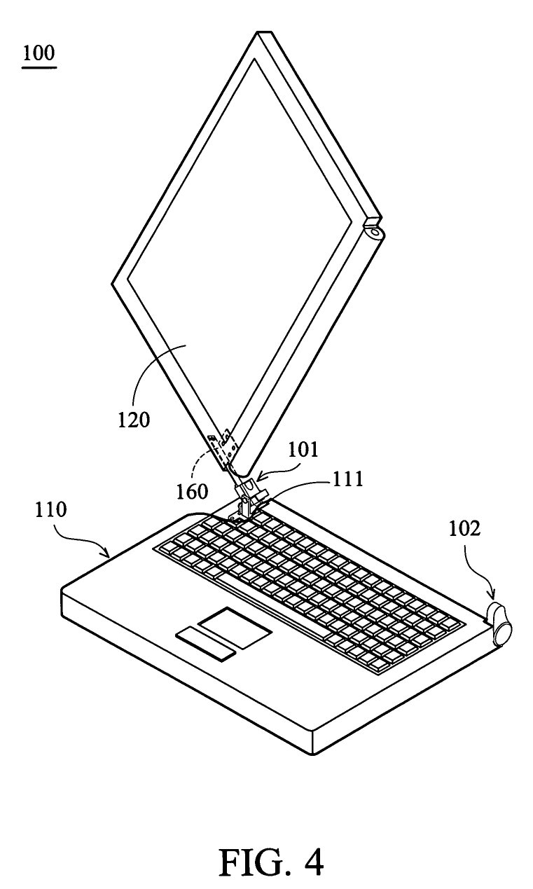

Moreover, as shown in FIG. 4, an engaging hole 111 is formed on the housing of the host 110. The engaging hook 153 of the second rotating base 150 is selectively engaged in the engaging hole 111.

The following description is directed to operation of the LCD monitor 120 and host 110 of the notebook computer 100.

As shown in FIG. 1, when the LCD monitor 120 is connected to the host 110 by means of the multi-directional rotating mechanism 101 and release/lock hinge 102, the engaging hook 153 of the second rotating base 150 is engaged in the engaging hole 111 of the host 110. At this point, as the second rotating base 150 cannot rotate, the first rotating base 140 connected thereto cannot rotate with respect to the fixed base 130. Thus, when turned, the LCD monitor 120 can rotate only in the third direction C with respect to the second rotating base 150 by way of the third pivot 190. Namely, the LCD monitor 120 can only rotatably open from and close onto the host 110.

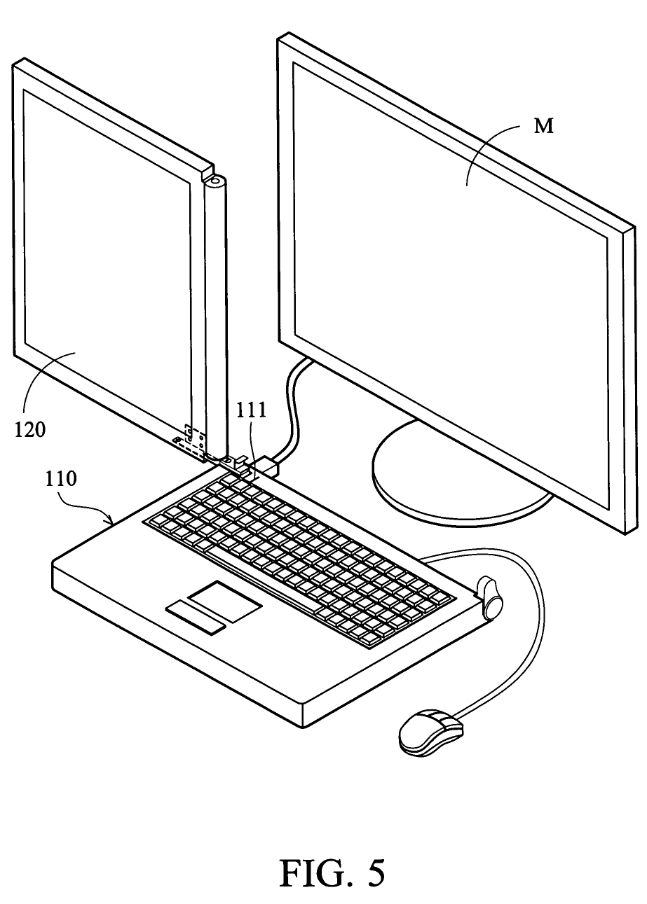

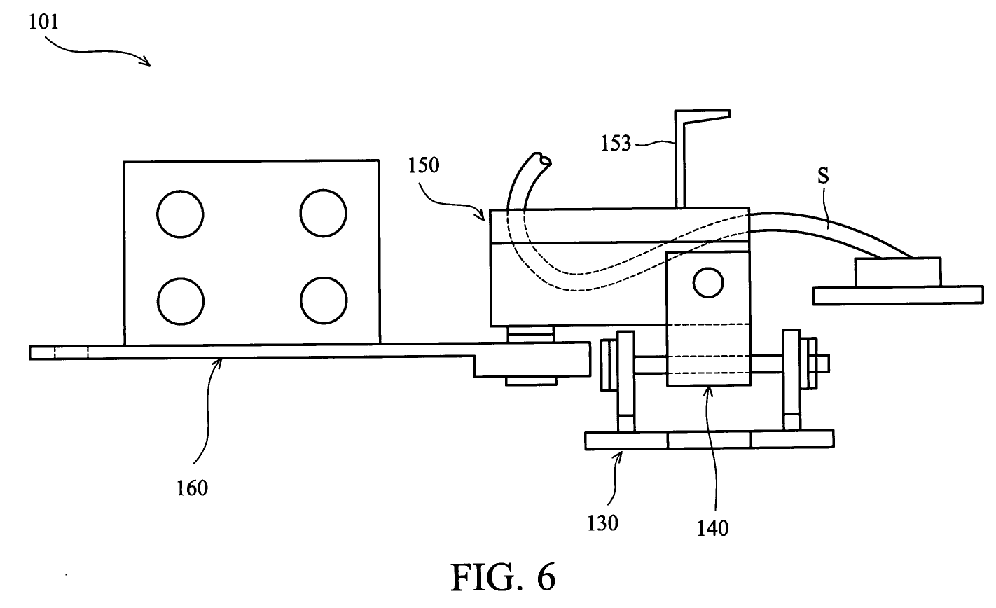

In another aspect, when the button 102a of the release/lock hinge 102 is pressed, one end of the LCD monitor 120 can be separated from the release/lock hinge 102 (or host 110), as shown in FIG. 4. The LCD monitor 120 can then be rotated counterclockwise (the LCD monitor 120 rotates in the second direction B with respect to the first rotating base 140 by way of the second rotating base 150) to a position shown in FIG. 5. At this point, the LCD monitor 120 is beside the host 110 and an additional monitor M can be connected to the host 110. The LCD monitor 120 and monitor M can together serve as operating interfaces, or only the monitor M serves as an operating interface. FIG. 6 is a schematic plan view of the multi-directional rotating mechanism 101 when the LCD monitor 120 rotates to the position shown in FIG. 5.

Accordingly, when rotating to the position shown in FIG. 5, the LCD monitor 120 can be turned, adjusting inclination thereof. Specifically, the inclination of the LCD monitor 120 is adjusted by turning the LCD monitor 120 to rotate the first rotating base 140 in the first direction A.

Additionally, when rotating to the position shown in FIG. 5, the LCD monitor 120 can be turned, rotating the supporting frame 160 connected thereto in the third direction C.

Moreover, the notebook computer is not limited to a conventional release/lock hinge. Namely, the LCD monitor can be connected to the host by only a multi-directional rotating mechanism 101, with open and close operations of the LCD monitor and host not adversely affected.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a host;
a fixed base fixed to the host;
a first rotating base rotatably disposed on the fixed base and rotating in a first direction with respect to the fixed base;
a second rotating base rotatably disposed on the first rotating base and rotating in a second direction with respect to the first rotating base, wherein the central rotating axis of the second direction is perpendicular to that of the first direction;
a supporting frame rotatably connected to the second rotating base and rotating in a third direction with respect to the second rotating base, wherein the central rotating axis of the third direction is perpendicular to that of the second direction; and
a monitor connected to the supporting frame and rotating in the first, second, and third directions with respect to the host by way of the first rotating base, second rotating base, and supporting frame, respectively.

2. The electronic device as claimed in claim 1, further comprising a first pivot disposed in the fixed base and first rotating base, wherein the first rotating base rotates in the first direction with respect to the fixed base by way of the first pivot.

3. The electronic device as claimed in claim 2, wherein the fixed base further comprises a base plate and two first pivoting portions, the first pivoting portions protrude from the base plate, the first rotating base is disposed between the first pivoting portions and separated from the base plate, each first pivoting portion comprises a first pivot hole, the first rotating base comprises a second pivot hole, and the first pivot is disposed in the first and second pivot holes.

4. The electronic device as claimed in claim 1, further comprising a second pivot disposed in the first and second rotating bases, wherein the second rotating base rotates in the second direction with respect to the first rotating base by way of the second pivot.

5. The electronic device as claimed in claim 4, wherein the first rotating base further comprises two second pivoting portions, each second pivoting portion comprising a third pivot hole, the second rotating base is disposed between the second pivoting portions and comprises a fourth pivot hole, and the second pivot is disposed in the third and fourth pivot holes.

6. The electronic device as claimed in claim 1, further comprising a third pivot disposed in the supporting frame and second rotating base, wherein the supporting frame rotates in the third direction with respect to the second rotating base by way of the third pivot.

7. The electronic device as claimed in claim 1, wherein the second rotating base further comprises a through hole, through which a signal cable is passed, by means of which the monitor is electrically connected to the host.

8. The electronic device as claimed in claim 1, wherein the second rotating base further comprises an engaging hook, and the host further comprises an engaging hole to which the engaging hook is selectively engaged.

9. The electronic device as claimed in claim 1, wherein the fixed base is fixed to one corner of the host.

10. The electronic device as claimed in claim 1, wherein the monitor comprises an LCD monitor.

11. The electronic device as claimed in claim 1, wherein the electronic device comprises a notebook computer.

12. A multi-directional rotating mechanism, comprising:
a fixed base;
a first rotating base rotatably disposed on the fixed base and rotating in a first direction with respect to the fixed base;
a second rotating base rotatably disposed on the first rotating base and rotating in a second direction with respect to the first rotating base, wherein the central rotating axis of the second direction is perpendicular to that of the first direction; and
a supporting frame rotatably connected to the second rotating base and rotating in a third direction with respect to the second rotating base, wherein the central rotating axis of the third direction is perpendicular to that of the second direction.

13. The multi-directional rotating mechanism as claimed in claim 12, further comprising a first pivot disposed in the fixed base and first rotating base, wherein the first rotating base rotates in the first direction with respect to the fixed base by way of the first pivot.

14. The multi-directional rotating mechanism as claimed in claim 13, wherein the fixed base further comprises a base plate and two first pivoting portions, the first pivoting portions protrude from the base plate, the first rotating base is disposed between the first pivoting portions and separated from the base plate, each first pivoting portion comprises a first pivot hole, the first rotating base comprises a second pivot hole, and the first pivot is disposed in the first and second pivot holes.

15. The multi-directional rotating mechanism as claimed in claim 12, further comprising a second pivot disposed in the first and second rotating bases, wherein the second rotating base rotates in the second direction with respect to the first rotating base by way of the second pivot.

16. The multi-directional rotating mechanism as claimed in claim 15, wherein the first rotating base further comprises two second pivoting portions, each second pivoting portion comprising a third pivot hole, the second rotating base is disposed between the, second pivoting portions and comprises a fourth pivot hole, and the second pivot is disposed in the third and fourth pivot holes.

17. The multi-directional rotating mechanism as claimed in claim 12, further comprising a third pivot disposed in the supporting frame and second rotating base, wherein the supporting frame rotates in the third direction with respect to the second rotating base by way of the third pivot.
